(19) United States
(12) Patent Application Publication
(10) Pub. No.: US 2008/0156346 A1
(43) Pub. Date: Jul. 3, 2008

(54) METHOD AND APPARATUS FOR CLEANING A SUBSTRATE

(75) Inventors: Hsien-Cheng Wang, Hsinchu (TW); Hung Chang Hsieh, Hsin-Chu City (TW); Tsiao-Chen Wu, Hsin-Chu (TW); Jian-Hong Chen, Hsin-Chu (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/616,964

(22) Filed: Dec. 28, 2006

(51) Int. Cl. B08B 3/08; B08B 1/04; B08B 11/02

(52) U.S. Cl. 134/1.3; 134/6; 134/1; 134/58 R; 134/57 R

(57) ABSTRACT

A method for photolithography processing includes forming a photoresist layer on a surface of a substrate, baking the substrate to remove solvents from the photoresist layer, cleaning an edge of the substrate with a tape, and exposing the photoresist layer with radiation energy. The tape includes a cleaning material. The tape is positioned proximate to or in contact with the edge of the substrate while the substrate is rotating.

### BACKGROUND

As semiconductor fabrication technologies are continually progressing to smaller feature sizes such as 65 nanometers, 45 nanometers, and below, immersion lithography methods are being adopted. Immersion lithography is a resolution enhancement technique for exposing images on a substrate such as a surface of a semiconductor substrate.

Immersion lithography typically involves exposing a photoresist or resist layer to a pattern through an immersion fluid disposed in the space between a projection lens of an immersion lithography system and the resist layer. The resist layer is applied to the surface of the substrate by a spin coating process. However, there may be resist that forms on an edge of the substrate during spin coating and, when dry, can flake off and cause particles to contaminate active areas of the substrate and/or processing equipment such as the immersion lithography system. This can lead to pattern defects, pattern distortion, and/or pattern loss.

What is needed is an improved and cost-effective method for removing undesirable particles and residues from the edge of the substrate.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of one embodiment of a method for cleaning a substrate.

FIG. 2 is a partial cross section view of a substrate having a photoresist layer formed by a spin coating process.

FIG. 3 is a cross section view of part of a substrate following a backside rinse process.

FIG. 4 is a perspective view of an apparatus for cleaning a substrate according to one embodiment of the present disclosure.

FIG. 5 is a top view of the cleaning apparatus of FIG. 4.

FIG. 6 is a perspective view of a substrate that has been cleaned with the apparatus of FIG. 4.

### DETAILED DESCRIPTION

It is understood that the following disclosure provides many different embodiments, or examples, capable of implementing different features of the invention. Specific examples of components and arrangements are described below to simplify and thus clarify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed interposing the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

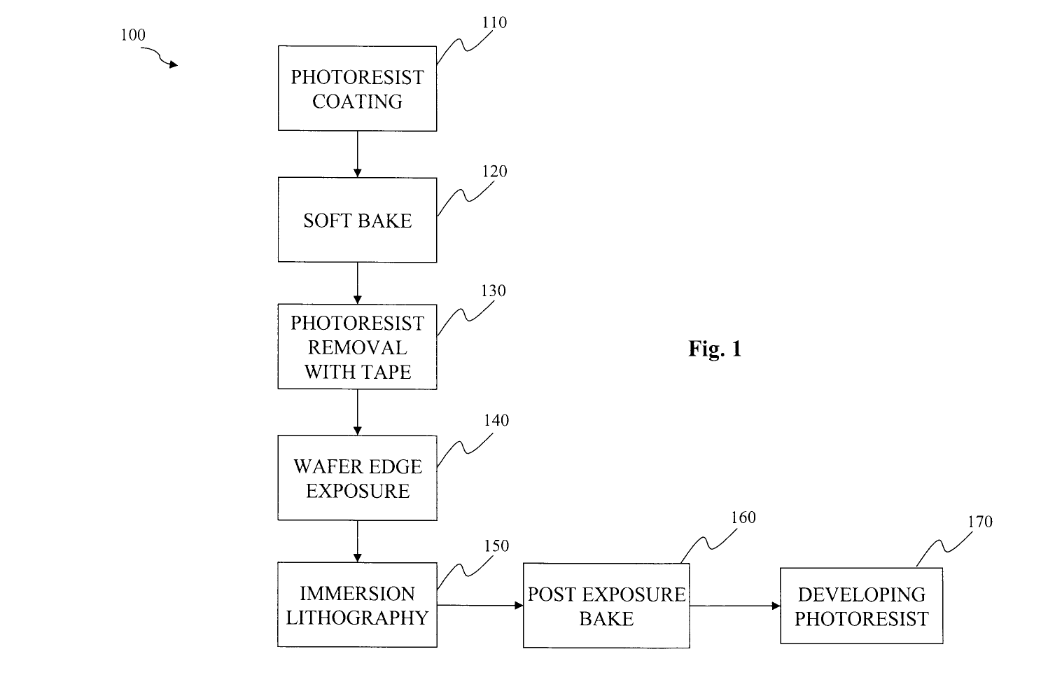

Referring to FIG. 1, illustrated is a flowchart of one embodiment of a method 100 for photolithography processing. The method 100 begins with step 110 in which a photoresist layer (resist layer or photosensitive layer) is formed on a surface of a substrate. After the surface of the substrate has been cleaned and primed, the photoresist layer may be applied to the surface by spin coating. The process of spin coating is known in the art and thus, will not be discussed in detail here. Due to the centrifugal force of spin coating, photoresist may flow toward the edge of the substrate and onto the backside of the substrate. This photoresist layer that forms on the edge and backside of the substrate may be referred to as an edge bead. The edge bead, when dry, may flake off and cause particles to contaminate active areas of the substrate and/or processing equipment.

The substrate may undergo an edge-bead removal (EBR) process in which a small amount of solvent is sprayed on the underside of substrate while it is spinning to remove the edge bead. However, without careful control, the solvent may lap up over the edge and reach the topside of the substrate resulting in density defects of the photoresist layer. Another approach for removing the edge bead is by a wafer edge exposure (WEE) process. The WEE process may involve exposing the photoresist (e.g., negative photoresist) with radiation energy while masking the edge of the substrate and thereafter developing the photoresist. Because the photoresist at the edge of the substrate was masked and unexposed to the radiation energy, the unexposed photoresist is removed by the developer. However, the WEE process does not remove the photoresist before a main exposure step, and thus, the photoresist at the edge of the substrate may introduce particles to an immersion lithography system. Accordingly, the description that follows provides a simple and cost-effective method for cleaning the edge of the substrate.

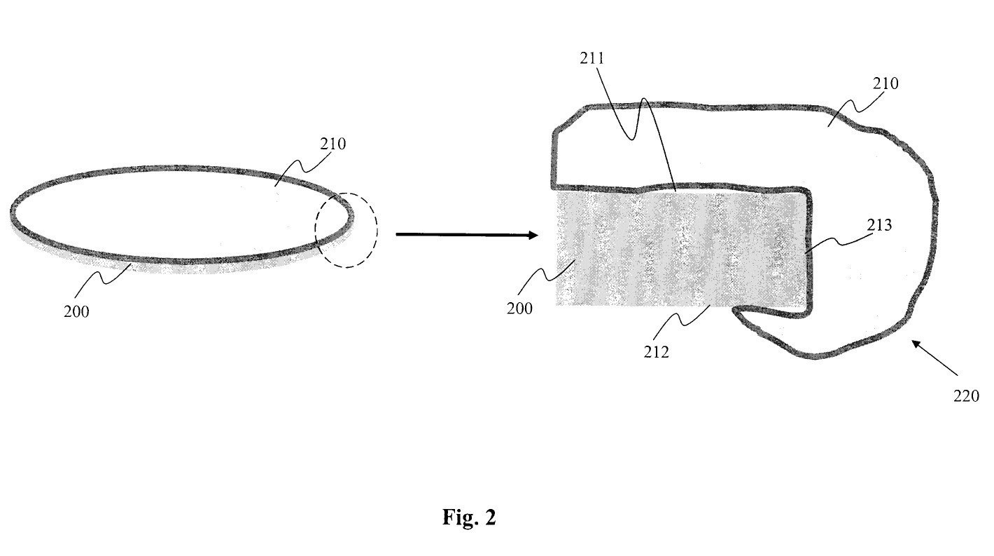

Referring now also to FIG. 2, illustrated is a substrate 200 that has been spin coated with a photoresist as was described in step 110 of method 100. The substrate 200 may be a semiconductor substrate. In the present embodiment, the substrate 200 includes silicon. The substrate 200 may alternatively include other suitable semiconductor material, including Ge, SiGe, or GaAs. The substrate 200 may further include other materials such as low k dielectric material, silicon oxide, and conductive material. The substrate 200 may have other structures such as doped regions including wells and source/drain; isolations features including shallow trench isolation (STI) and inter-level dielectric (ILD); conductive features including gate electrodes, metal lines, vias, and contacts. The substrate 200 may alternatively include a non-semiconductor material such as a glass plate for thin-film-transistor liquid-crystal display (LCD) devices or a fused quartz plate for photomasks. The substrate 200 may further include one or more material layers to be patterned. For example, the material layer(s) to be patterned may include a silicon layer, a dielectric layer, or a doped poly-silicon layer.

Additionally, the substrate 200 may include a bottom anti-reflecting coating (BARC) layer formed on the material layer(s) to be patterned. The BARC layer is designed to have a proper refractive index and/or a thickness to reduce light reflection during a lithography process and enhance lithography patterning performance. The BARC layer may include an organic material, a nitride material, or an oxide material.

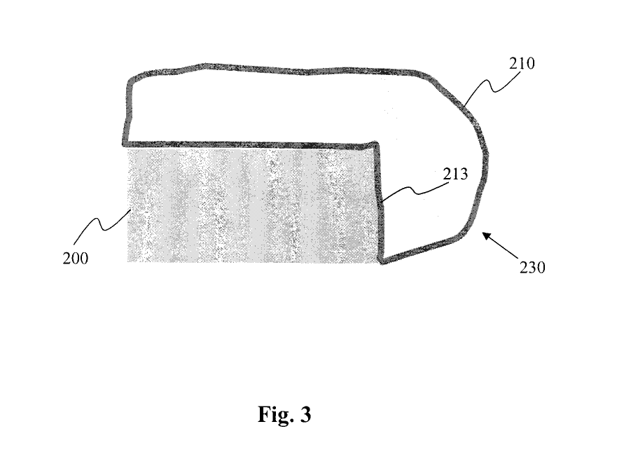

The photoresist layer 210 may be formed on a surface 211 of the substrate 200 by spin coating. As previously discussed, photoresist may form on the backside 212 and on the edge 213 of the substrate 200 and may be referred to as an edge bead 220. Now referring also to FIG. 3, following spin coating, the substrate 200 may undergo a backside rinse before entering an immersion lithography system for a main exposure step. However, photoresist 230 may still remain at the edge 213 of the substrate 200 which can introduce particles to the immersion lithography system. Thus, photoresist 230 on the edge 213 may be removed before the substrate 200 is transferred to the immersion lithography system.

Referring again to FIG. 1, the method 100 continues with step 120 in which a baking process may be applied to the photoresist layer 210 to reduce solvent in the photoresist layer, referred to as a soft baking process. The substrate 200 may be baked on a hot plate. Following the soft baking process, the substrate 200 may be cooled to room temperature on a cooling plate.

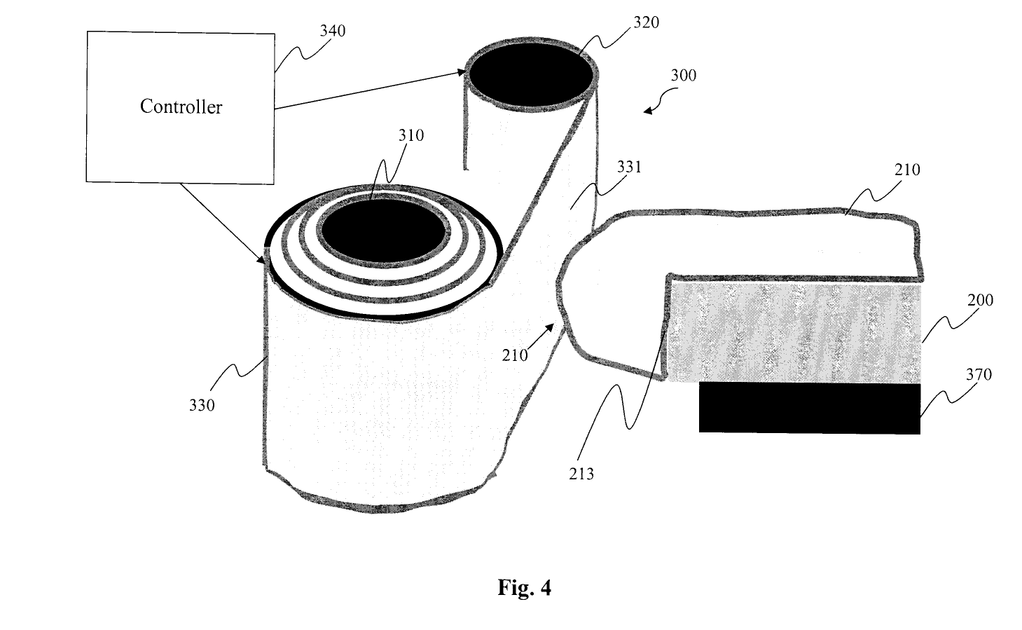

The method 100 continues with step 130 in which the photoresist 230 at the edge 213 of the substrate 200 may be cleaned and removed with a tape. Referring now also to FIG. 4, illustrated is a cleaning apparatus 300 that may be used in step 130 of method 100 of FIG. 1. The cleaning apparatus 300 may comprise of a first spool 310 and a second spool 320 for winding a tape or roll of tape 330. The first and second spool 310, 320 may each comprise of a cylindrical plate or other cylindrical device. The first and second spools 310, 320 may be coupled to motors (not shown), such as micro-motors, for rotating the spools. The cleaning apparatus 300 may further comprise of a controller 340 that is coupled to the first and second spools 310, 320 for controlling a rotational speed, rotational direction, position, torque, and/or other parameters of the first and second spools.

The roll of tape 330 may be wound between the first and second spools 310, 320. Even though one roll of tape 330 is shown, it is understood that multiple rolls may be used and disposed between the first and second spools 310, 320 at different heights. The spools 310, 320 may be moved up and down to change the roll of tape that is being used to clean the substrate 200. The tape 330 may comprise of a cleaning material including an adhesive layer 331. Alternatively, the cleaning material may comprise of an adhesive layer 331 coated with a thinner material or other suitable material known in the art. Additionally, the tape 330 may have a porous surface.

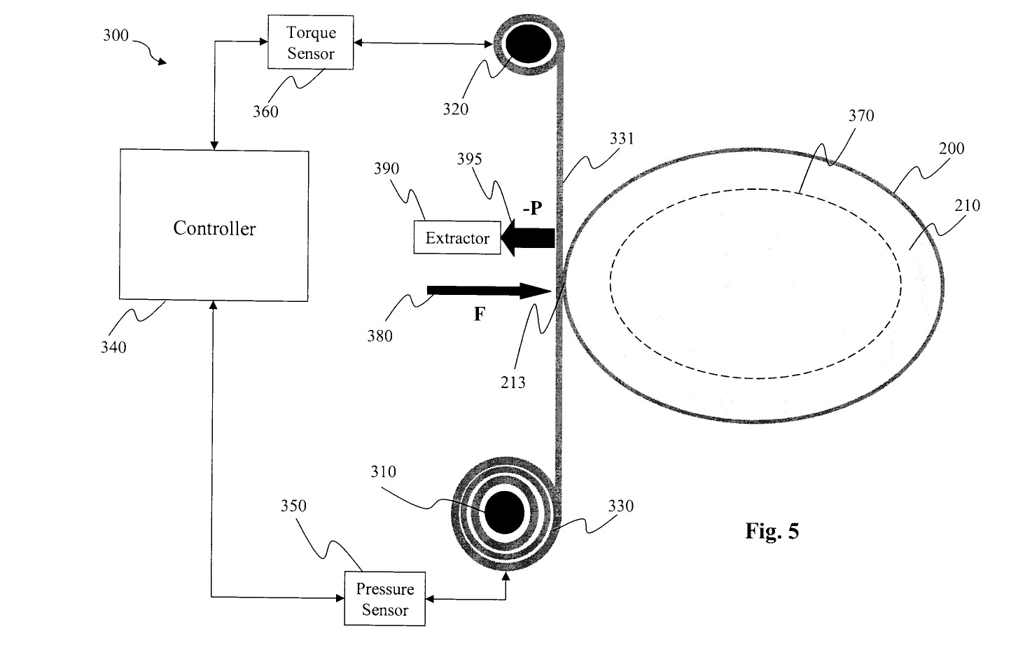

Referring now also to FIG. 5, illustrated is a top view of the cleaning apparatus 300 of FIG. 4. The cleaning apparatus 300 may further comprise a pressure sensor 350 and a torque sensor 360 that may be coupled to the controller 340. The pressure sensor 350 may be configured to sense an amount of pressure between the roll of tape 330 and the edge 213 of the substrate 200. The pressure sensor 350 may be configured to have a sensitivity from about 0.1 mbar to 100 bar. The torque sensor 360 may be configured to sense an amount of torque between the first and second spools 310, 320. The torque sensor 360 may be configured to have a sensitivity from about 0.01 in-lbs to 1000 in-lbs.

During operation, the substrate 200 may be securely positioned and held on a stage 370. For example, the stage 370 may comprise of a vacuum chuck that secures the substrate 200 through small vacuum holes on its surface. The stage 370 may be coupled to a motor, such as a micro-motor, for rotating the stage. The controller 340 may be coupled to the motor and the stage 370 to control a rotational speed, rotational direction, and position of the stage. The stage 370 may rotate the substrate 200 in either direction. The controller 340 may wind the tape 330 such that the tape moves in a same direction relative to the rotating substrate 200. For example, the stage 370 may rotate the substrate 200 in a clockwise direction while the first and second spools 310, 320 rotate in a counterclockwise direction. In this way, the tape 330 may move in the same direction relative to the rotating substrate 200. Alternatively, the controller 340 may optionally wind the tape 330 such that the tape moves in an opposite direction relative to the rotating substrate 200. For example, the stage 370 may rotate the substrate 200 in a clockwise direction while the first and second spools 310, 320 rotate in a clockwise direction. In this way, the tape 330 may move in the opposite direction relative to the rotating substrate 200.

The tape 330 with the adhesive layer 331 coated with the thinner material may be positioned to face the edge 213 of the substrate 200. The controller 340 may position the tape 330 proximate to or in contact with the edge 213 of the substrate 200 while the stage 370 is rotating the substrate. This can be done by the controller 340 moving the tape 330 relative to the stage 370 or moving the stage relative to the tape. The tape 330 may be pushed by a force (F) 380 to the edge 213 of the substrate 200. The photoresist 230 at the edge 213 of the substrate 200 may adhere to the tape 330. Additionally, other particles at the edge 213 of the substrate may also adhere to the tape 330. Moreover, the substrate 200 may be configured to be porous to enhance adhesion of the particles and/or photoresist to the tape 330. For example, the substrate 200 may be configured to have a pore size ranging between about 10 nm to 1000 nm.

The cleaning apparatus 300 may further comprise an extractor 390 that provides a negative pressure (−P) 395 on the tape 330. For example, the negative pressure 395 acts to pull on the tape 330 and thus, may extract photoresist adhered to the tape through the porous surface of the tape. Since the tape 330 may be wound while the substrate 200 is rotating, there will always be a new or fresh area of tape that is available for cleaning photoresist and/or particles at the edge 213 of the substrate. Furthermore, the tape 330 may be configured to be disposable for easy maintenance.

The pressure sensor 360 may sense the amount of pressure between the tape 330 and the edge 213 of the substrate. The controller 340 may adjust the position of the tape 330 and/or the substrate 200 based on the amount of pressure that is sensed . For example, if the pressure sensed is less than a desired pressure, the controller 340 may move the tape 330 closer to the edge 213 of the substrate 200 so that more pressure may be applied for cleaning the edge of the substrate. The torque sensor 370 may sense the amount of torque between the first and second spools 310, 320. The controller 340 may adjust the position of the tape 330 and/or the substrate 200 based on the sensed amount of torque that is sensed. For example, if the torque sensed is greater than a desired torque, the controller 340 may move the tape 330 away from the edge 213 of the substrate 200 to reach the desired torque. Accordingly, the controller 340 may precisely control the touching between the tape 330 and the edge 213 of the substrate 200.

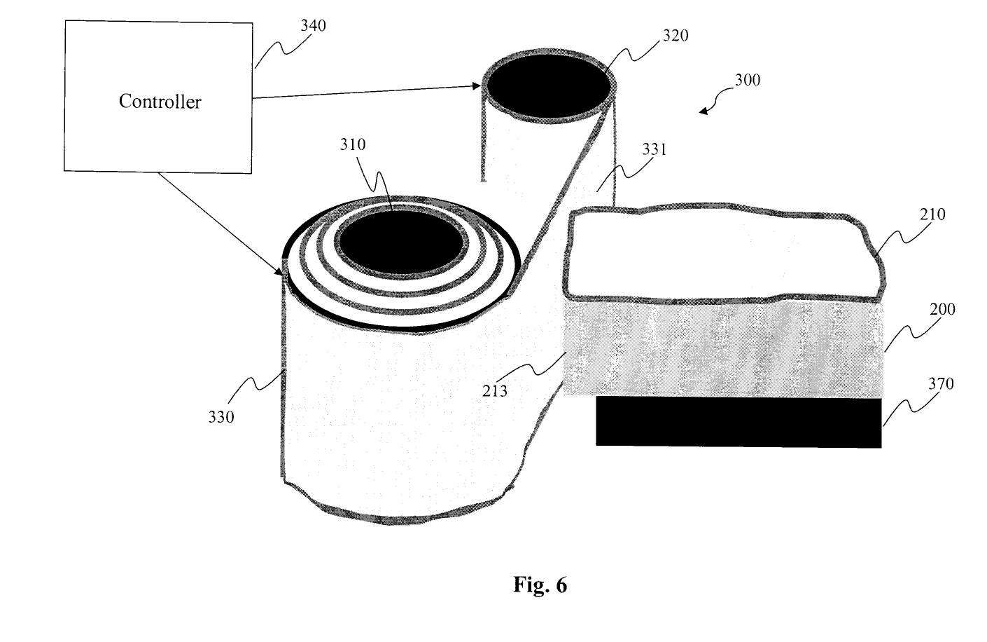

Referring now also to FIG. 6, illustrated is the cleaning apparatus 300 of FIG. 4 cleaning the edge 213 of the substrate 200. The controller 340 moves the tape 330 closer to the edge 213 of the substrate 200 until the edge is cleaned free of particles and/or photoresist. Alternatively, the controller 340 may optionally move the edge 213 of the substrate 200 closer to the tape 330 until the edge is cleaned free of particles and/or photoresist. The pressure sensor 350 and torque sensor 360 may indicate to the controller 340 the end to the cleaning process.

Referring again to FIG. 1, the method 100 continues with step 140 in which the photoresist layer 210 may undergo a wafer edge exposure (WEE) process. The WEE process may expose a portion of the photoreist layer 210 by the edge 213 of the substrate 200.

The method 100 continues with step 150 in which the photoresist layer 210 undergoes a main exposure process. The main exposure process may be performed utilizing an immersion lithography technique wherein an immersion fluid is disposed between the lens of a lithography tool and the substrate 200 during the exposure process. For example, de-ionized water (DI water or DIW) may be used as the immersion fluid. Because the edge 213 of the substrate 200 has been cleaned in step 130, there will be substantially less particles that may contaminate the immersion fluid and cause defects when exposing the photoresist layer 210.

The immersion lithography system to implement the main exposure process is described below as an example. The system includes a substrate stage designed to secure a substrate 200 to be processed. The substrate stage is operable to move the substrate relative to the apparatus. For example, the substrate stage is capable of translational and/or rotational displacement for substrate alignment, stepping, and scanning. The substrate stage may include various components suitable to perform precise movement. The immersion lithography system further includes one or more imaging lens systems (referred to as a “lens system”). The substrate 200 may be positioned on the substrate stage under the lens system. Each lens element thereof may include a transparent substrate and may further include a plurality of coating layers. The transparent substrate may be a conventional objective lens, and may be made of fused silica (SiO2), calcium-fluoride (CaF2), lithium fluoride (LiF), barium fluoride (BaF2), or other suitable material. The materials used for each lens element may be chosen based on the wavelength of light used in the lithography process to minimize absorption and scattering.

The immersion lithography system may include an immersion fluid retaining module designed for holding an immersion fluid and/or other proper fluid such as a cleaning fluid. The immersion fluid retaining module may be positioned proximate (such as around) the lens system and designed for other functions, in addition to holding the immersion fluid. The immersion fluid retaining module may include various apertures (or nozzles) for providing an immersion fluid for an exposure process, and/or performing other proper functions.

The immersion lithography system may further include a radiation source. The radiation source may be a suitable ultraviolet (UV) or extra UV(EUV) light source. For example, the radiation source may be a mercury lamp having a wavelength of 436 nm (G-line) or 365 nm (I-line); a Krypton Fluoride (KrF) excimer laser with wavelength of 248 nm; an Argon Fluoride (ArF) excimer laser with a wavelength of 193 nm; a Fluoride (F2) excimer laser with a wavelength of 157 nm; or other light sources having a desired wavelength (e.g., below approximately 100 nm).

Referring again to FIG. 1, the method 100 continues with step 160 in which the exposed photoresist layer 210 may undergo a post exposure baking (PEB) process. During the PEB process, the photo generated acid induces a cascade of chemical transformations in the photoresist layer 210, referred to as chemical amplification. The transformations turn the exposed regions of the photoresist layer 210 into photoresist features soluble to a developer. The PEB process may have a temperature (or a temperature profile as a function of time) and a baking duration defined and controlled for optimized resist patterning.

The method 100 then proceeds to step 170 in which the photoresist layer 210 is developed utilizing a developer. The photoresist layer 210 in the exposed regions are substantially dissolved, resulting in a patterned photoresist layer having one or more openings and an exposed substrate 200 within the openings. In one embodiment, the developer may be a tetramethylammonium hydroxide (TMAH) based solution. Following developing of the photoresist layer, the substrate 200 may undergo further processing known in the art such as baking, etching/implanting, and/or stripping the photoresist layer. Even though the present method was disclosed as being implemented in an immersion lithography system, it is understood that the method is applicable in other lithography and/or semiconductor processing systems that involve processing substrates.

Thus, the present disclosure provides a method for photolithography processing. The method comprises forming a photoresist layer on a surface of a substrate, baking the substrate to remove solvents from the photoresist layer, cleaning an edge of the substrate with a tape, and exposing the photoresist layer with radiation energy. The step of cleaning includes configuring the tape to include a cleaning material. The step of cleaning also includes positioning the tape proximate to or in contact with the edge of the substrate while the substrate is rotating. In some embodiments, the method further comprises performing a wafer edge exposure process, baking the exposed photoresist layer, and developing the exposed photoresist layer. In other embodiments, the step of cleaning includes moving the tape in a same direction relative to the rotating substrate. In still other embodiments, the step of cleaning includes moving the tape in an opposite direction relative to the rotating substrate.

In other embodiments, the step of cleaning includes configuring the tape to be porous. The method further comprises applying a negative pressure on the tape to extract particles and photoresist adhered to the tape from the cleaning step. In some embodiments, the cleaning material includes an adhesive and a thinner. In some other embodiments, the substrate is of a type select from a group consisting of: a semiconductor substrate, a photomask substrate, and a liquid-crystal display (LCD) substrate. In still other embodiments, the step of exposing includes exposing the photoresist layer in an immersion lithography system.

Additionally, the present disclosure provides an apparatus for cleaning an edge of a substrate. The apparatus comprises a tape having a surface coated with a cleaning material, a set of spools, and a controller configured and operable to position the edge of the substrate proximate to or in contact with the surface of the tape coated with the adhesive and cleaning material while the substrate is rotating. The tape is wound between the set of spools. In some embodiments, the apparatus further comprises motors coupled to the set of spools for winding the tape. In other embodiments, the set of spools wind the tape such that the tape moves in a same direction relative to the rotating substrate. In still other embodiments, the set of spools wind the tape such that the tape moves in an opposite direction relative to the rotating substrate.

In another embodiment, the apparatus further comprises an extractor for extracting particles and photoresist adhered to the tape. The extractor is configured to provide a negative pressure on the tape. In other embodiments, the apparatus further comprises a pressure sensor for sensing an amount of pressure between the surface of the tape and the edge of the substrate and a torque sensor for sensing an amount of torque between the set of spools. The controller adjusts the position of the edge of the substrate relative to the surface of the tape based on the amount of pressure and torque that is sensed.

Also provided is a system for cleaning a substrate. The system comprises a stage for holding the substrate, a cleaning module, and a controller. The cleaning module comprises a roll of tape having a surface coated with a cleaning material, a first spool and a second spool, the tape is wound between the first and second spools. The controller is configured and operable to position the surface of the tape coated with the cleaning material proximate to or in contact with an edge of the substrate while the stage is rotating the substrate. In some embodiments, the roll of tape is wound in an opposite direction as the rotating substrate. In some other embodiments, the roll of tape is wound in a same direction as the rotating substrate. In still other embodiments, the system further comprises a pressure sensor coupled to the cleaning module for sensing an amount of pressure between the surface of the tape and the edge of the substrate and a torque sensor coupled to the cleaning module for sensing an amount of torque between the first and second spools. The controller controls the position of the surface of the tape relative to the edge of the substrate based on the amount of pressure and torque that is sensed. In still other embodiments, the cleaning material includes an adhesive and a thinner.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. It is understood that various different combinations of the above-listed processing steps can be used in combination or in parallel. Also, features illustrated and discussed above with respect to some embodiments can be combined with features illustrated and discussed above with respect to other embodiments. Those skilled in the art should also realize that such equivalent constructions do not depart from the spirit and scope of the present disclosure, and that they may make various changes, substitutions and alterations herein without departing from the spirit and scope of the present disclosure.

Several different advantages exist from these and other embodiments. In addition to providing a simple and cost-effective method for cleaning an edge of a substrate, the method and apparatus disclosed herein are easily incorporated with lithography equipment including immersion lithography systems. By implementing the method and apparatus disclosed herein, the probability of introducing particles and contaminants in the operating environment of the immersion lithography system is greatly reduced. This is most important for going forward with mass production of semiconductor devices using immersion lithography.

1. A method, comprising:
providing a substrate;
cleaning an edge of the substrate with a tape; and
processing the substrate;
wherein the cleaning includes configuring the tape to include a cleaning material, wherein the cleaning includes positioning the tape proximate to or in contact with the edge of the substrate while the substrate is rotating.

2. The method of claim 9, wherein the processing the substrate includes:
exposing the photoresist layer with radiation energy in an immersion lithography system;
baking the exposed photoresist layer; and
developing the exposed photoresist layer.

3. The method of claim 1, wherein the cleaning includes moving the tape in a same direction relative to the rotating substrate.

4. The method of claim 1, wherein the cleaning includes moving the tape in an opposite direction relative to the rotating substrate.

5. The method of claim 1, wherein the cleaning includes configuring the tape to include a porous surface.

6. The method of claim 5, further comprising applying a negative pressure on the tape to extract particles and photoresist adhered to the tape from the cleaning step.

7. The method of claim 1, wherein the cleaning material includes an adhesive and a thinner.

8. The method of claim 1, wherein the substrate is of a type selected from the group consisting of: a semiconductor substrate, a photomask substrate, and a liquid-crystal display (LCD) substrate.

9. The method of claim 1, wherein the providing the substrate includes:
forming a photoresist layer on a surface of the substrate:
baking the substrate to remove solvents from the photoresist layer.

10. An apparatus for cleaning an edge of a substrate, comprising:
a tape having a surface coated with a cleaning material;
a set of spools, wherein the tape is wound between the set of spools; and
a controller configured and operable to position the edge of the substrate proximate to or in contact with the surface of the tape coated with the cleaning material while the substrate is rotating.

11. The apparatus of claim 10, further comprising motors coupled to the set of spools for winding the tape.

12. The apparatus of claim 11, wherein the set of spools wind the tape such that the tape moves in a same direction relative to the rotating substrate.

13. The apparatus of claim 11, wherein the set of spools wind the tape such that the tape moves in an opposite direction relative to the rotating substrate.

14. The apparatus of claim 10, further comprising an extractor for extracting particles and photoresist adhered to the tape, wherein the extractor is configured to provide a negative pressure on the tape.

15. The apparatus of claim 10, further comprising:
a pressure sensor for sensing an amount of pressure between the surface of the tape and the edge of the substrate; and
a torque sensor for sensing an amount of torque between the set of spools;
wherein the controller adjusts the position of the edge of the substrate relative to the surface of the tape based on the amount of pressure and torque that is sensed.

16. A system for cleaning a substrate, comprising:
a stage for holding the substrate;
a cleaning module, wherein the cleaning module comprises:
a roll of tape having a surface coated with a cleaning material;
a first spool and a second spool, wherein the roll of tape is wound between the first spool and the second spool; and
a controller configured and operable to position the surface of the tape coated with the cleaning material proximate to or in contact with an edge of the substrate while the stage is rotating the substrate.

17. The system of claim 16, wherein the roll of tape is wound in an opposite direction relative to the rotating substrate.

18. The system of claim 16, wherein the roll of tape is wound in a same direction relative to the rotating substrate.

19. The system of claim 16, further comprising:
a pressure sensor coupled to the cleaning module for sensing an amount of pressure between the surface of the tape and the edge of the substrate; and
a torque sensor coupled to the cleaning module for sensing an amount of torque between the first and second spools;
wherein the controller controls the position of the surface of the tape relative to the edge of the substrate based on the amount of pressure and torque that is sensed.

20. The system of claim 16, wherein the cleaning material includes an adhesive and a thinner.
